(19) United States
(12) Patent Application Publication
(10) Pub. No.: US 2011/0134326 A1
(43) Pub. Date: Jun. 9, 2011

(54) VIDEO PROCESSING APPARATUS

(75) Inventor: Hirotaka NAKAYAMA, Osaka (JP)

(73) Assignee: PANASONIC CORPORATION, Osaka (JP)

(21) Appl. No.: 13/019,828

(22) Filed: Feb. 2, 2011

Related U.S. Application Data
(63) Continuation of application No. PCT/JP2009/003747, filed on Aug. 5, 2009.

(30) Foreign Application Priority Data
Aug. 6, 2008 (JP) 2008-203503

(51) Int. Cl. H04N 5/445

(52) U.S. Cl. 348/569; 348/E05.099

(57) ABSTRACT

A video processing apparatus includes a device data storage configured to store device data which is information about connection of peripheral devices, a cable data storage configured to store cable data which is information about cables, a data controller configured to read out the device data of a selected one of the peripheral devices from the device data storage, and the cable data of a selected one of the cables from the cable data storage, a connection analyzer configured to determine one of the cables which is used to connect the video processing apparatus and the selected peripheral device together, based on the device data read out from the device data storage and the cable data read out from the cable data storage, and a display unit configured to display an image of the cable determined by the connection analyzer along with an image of the selected peripheral device.

### CROSS-REFERENCE TO RELATED APPLICATIONS

This is a continuation of PCT International Application PCT/JP2009/003747 filed on Aug. 5, 2009, which claims priority to Japanese Patent Application No. 2008-203503 filed on Aug. 6, 2008. The disclosures of these applications including the specifications, the drawings, and the claims are hereby incorporated by reference in their entirety.

### BACKGROUND

The present disclosure relates to video processing apparatuses, and more particularly, to techniques for facilitating connection between a video processing apparatus and a peripheral device.

In present-day audio-visual (AV) device systems, a device needs to be connected to a plurality of peripheral devices via a plurality of types of cables. To do so, it is often necessary to consult a fat user manual. For most users, connecting AV devices together is a difficult task.

An example technique for facilitating such a task of connecting AV devices together is described in Japanese Patent Publication No. 2005-31738. Specifically, when the names of two devices which a user desires to connect together are entered into a client on a network, terminal attributes of these devices are retrieved from an electronic manual database in a server. By referencing a connection table, it is determined whether or not there is a combination of terminal attributes of two terminals of the two devices which can be connected together. Image information about the two terminals which can be connected together is received and displayed.

### SUMMARY

According to the method of Japanese Patent Publication No. 2005-31738, it is necessary to repeatedly connect devices together while viewing images of two terminals to be connected together on a screen. The screen, however, only shows that the terminals can be connected together, and therefore, the user needs to determine what type of cable is actually used for which terminal.

The present disclosure describes implementations of a technique for facilitating a series of a user's tasks of connecting a video processing apparatus and a peripheral device together via a cable by displaying visual guidance for the user on a screen.

An example video processing apparatus includes a device data storage configured to store device data which is information about connection of peripheral device devices, a cable data storage configured to store cable data which is information about cables, a data controller configured to read out the device data of a selected one of the peripheral devices from the device data storage, and the cable data of a selected one of the cables from the cable data storage, a connection analyzer configured to determine one of the cables which is used to connect the video processing apparatus and the selected peripheral device together, based on the device data read out from the device data storage and the cable data read out from the cable data storage, and a display unit configured to display an image of the cable determined by the connection analyzer along with an image of the selected peripheral device.

With the video processing apparatus, the type of a cable which should be used is displayed, and therefore, the video processing apparatus and a peripheral device can be more easily connected together.

According to the example of the present disclosure, it is indicated what type of a cable should be used, and therefore, a user's task of connecting the video processing apparatus and a peripheral device together is facilitated. Also, an image of a cable etc. is displayed, and therefore, an appropriate connection can be provided without an error.

### BRIEF DESCRIPTION OF THE DRAWINGS

FIG. 1 is a block diagram showing a configuration of a video processing apparatus according to an embodiment of the present disclosure.

FIG. 2 is a block diagram showing an example configuration of a connection analyzer of FIG. 1.

FIG. 3 is a diagram showing an example start screen for guidance on device connection.

FIG. 4 is a diagram showing an example screen displaying a list of peripheral devices which can be connected to the video processing apparatus of FIG. 1.

FIG. 5 is a diagram showing a state in which some peripheral devices have been selected on the screen of FIG. 4.

FIG. 6 is a diagram showing an example screen indicating connections between the video processing apparatus and peripheral devices and a connection between peripheral devices.

FIG. 7 is a diagram showing an example screen displaying a list of cables.

FIG. 8 is a diagram for describing a state in which some cables have been selected on the screen of FIG. 7.

FIG. 9 is a diagram showing an example screen displaying the video processing apparatus, peripheral devices, and cables used for connection.

FIG. 10 is a diagram showing a guidance screen for connecting an antenna and a DVD recorder together.

FIG. 11 is a diagram showing a guidance screen for connecting a DVD recorder and the video processing apparatus together.

FIG. 12 is a diagram showing a screen displayed when an antenna, a DVD recorder, and the video processing apparatus are correctly connected together.

FIG. 13 is a diagram showing a guidance screen for connecting a game device and the video processing apparatus together.

FIG. 14 is a diagram showing a screen displayed when a game device and the video processing apparatus are correctly connected together.

### DETAILED DESCRIPTION

Embodiments of the present disclosure will be described hereinafter with reference to the accompanying drawings.

A connection may be an electrical or optical connection throughout the following description and the accompanying claims.

Functional blocks described herein may be typically implemented by hardware. For example, functional blocks may be formed as a part of an integrated circuit (IC) on a semiconductor substrate. Here, ICs include large-scale integrated (LSI) circuits, application-specific integrated circuits (ASICs), gate arrays, field programmable gate arrays (FPGAs), etc. Alternatively, all or a portion of functional blocks may be implemented by software. For example, such functional blocks may be implemented by a program executed by a processor. In other words, functional blocks described herein may be implemented by hardware, software, or any combination thereof.

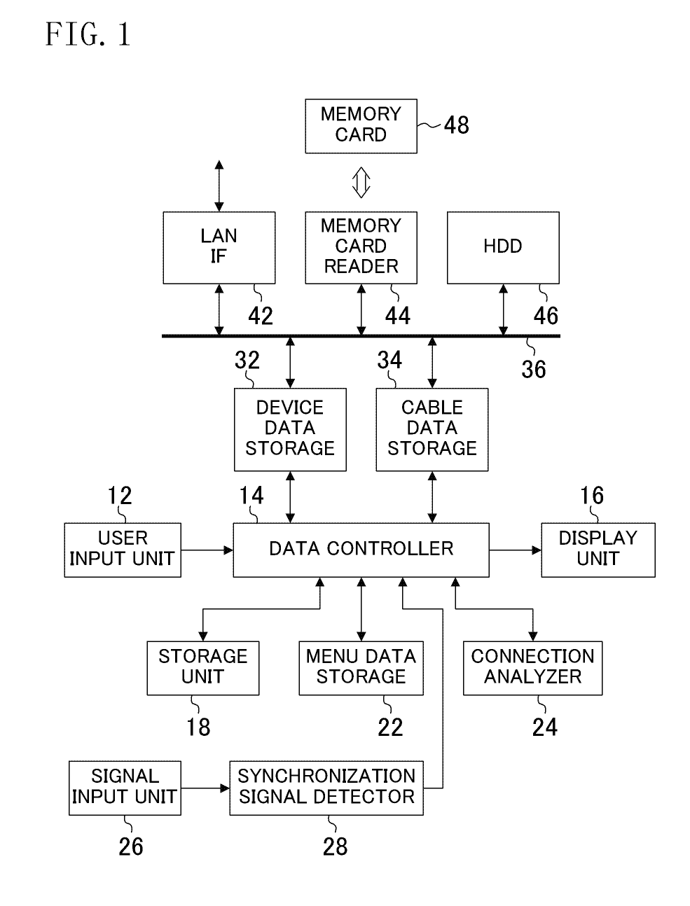

FIG. 1 is a block diagram showing a configuration of a video processing apparatus according to an embodiment of the present disclosure. The video processing apparatus of FIG. 1 includes a user input unit 12, a data controller 14, a display unit 16, a storage unit 18, a menu data storage 22, a connection analyzer 24, a signal input unit 26, a synchronization signal detector 28, a device data storage 32, a cable data storage 34, a bus 36, a local area network (LAN) interface 42, a memory card reader 44, and a hard disk drive (HDD) 46.

The video processing apparatus of FIG. 1 is, for example, a television (hereinafter referred to as a TV), and has a tuner (not shown). The tuner generates a video signal from a signal received by an antenna, and causes the display unit 16 to display the video signal. Also, a signal input to the signal input unit 26 is displayed on the display unit 16.

The user input unit 12 is, for example, a combination of a remote controller and a receiver, or an input button provided on a surface of the video processing apparatus of FIG. 1. The user performs input operation using the user input unit 12 based on displayed information on the display unit 16. The LAN interface 42 is connected to an external network (e.g., the Internet). A memory card 48 is detachably connected to the memory card reader 44. The LAN interface 42, the memory card reader 44, and the HDD 46 receive and output data via the bus 36 from and to the device data storage 32 and the cable data storage 34. Device data and cable data are previously stored in the memory card 48 and the HDD 46.

The device data storage 32 and the cable data storage 34, when not storing required data, downloads the required data via the LAN interface 42 from a predetermined site on the Internet. The device data storage 32 and the cable data storage 34 may also read out the required data from the memory card 48 using the memory card reader 44, or from the HDD 46.

The device data storage 32 accumulates device data transferred from the LAN interface 42, the memory card reader 44, and the HDD 46. The device data refers to information about a connection of a peripheral device, including terminal information indicating the type of a terminal of the peripheral device, image data including an image of the terminal, image data indicating an external appearance of the peripheral device, etc.

The cable data storage 34 accumulates cable data transferred from the LAN interface 42, the memory card reader 44, and the HDD 46. The cable data refers to information about a cable, including terminal information indicating the type of a terminal of the cable, image data including an image of the terminal, image data indicating an external appearance of the cable, instructions for the cable, and the like. The instructions for a cable are, for example, that for high-definition multimedia interface (HDMI) cables, the resolution of the output needs to be set, or that for WEE1394 cables, an analog connection cable should be used in conjunction with them.

The menu data storage 22 stores display data (a menu screen, etc.) which is to be displayed on the display unit 16. Based on information input to the user input unit 12 by the user, the data controller 14 reads out corresponding data from the device data storage 32, the cable data storage 34, and the menu data storage 22.

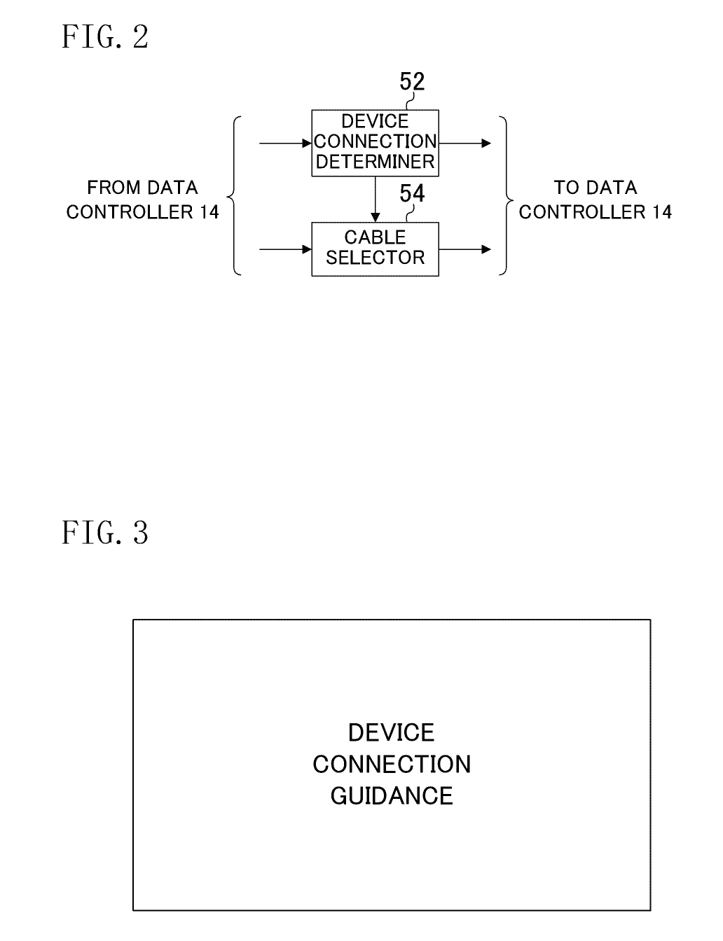

FIG. 2 is a block diagram showing an example configuration of the connection analyzer 24 of FIG. 1. As shown in FIG. 2, the connection analyzer 24 includes a device connection determiner 52 and a cable selector 54. The device connection determiner 52 analyzes a connection between the video processing apparatus of FIG. 1 and a peripheral device based on the device data read out by the data controller 14 and the information input to the user input unit 12, and outputs the result to the cable selector 54 and the data controller 14.

The cable selector 54 selects a cable used for connecting the video processing apparatus and a peripheral device together and a cable used for connecting peripheral devices together based on the result of the analysis by the device connection determiner 52, the cable data read by the data controller 14, and the information input to the user input unit 12, and outputs the result to the data controller 14. The display unit 16 displays, for example, images of the cable used for connecting the video processing apparatus and a peripheral device together and the cable used for connecting peripheral devices together based on the result of the analysis by the connection analyzer 24.

A procedure for connection will be described with reference to screens displayed on the display unit 16. FIG. 3 is a diagram showing an example start screen for guidance on device connection. When the user performs predetermined operation with respect to the user input unit 12, or when the video processing apparatus is turned on for the first time, the data controller 14 reads out data from the menu data storage 22, and causes the display unit 16 to display an image based on the data as shown in FIG. 3.

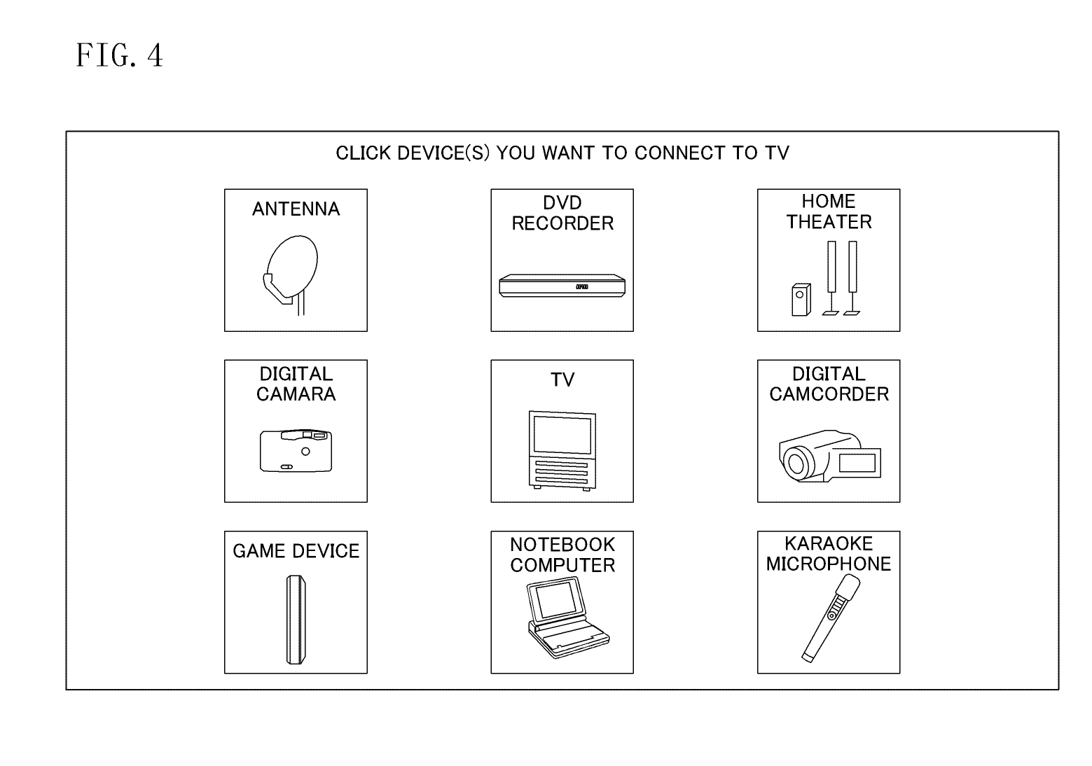

FIG. 4 is a diagram showing an example screen displaying a list of peripheral devices which can be connected to the video processing apparatus of FIG. 1. After the screen of FIG. 3 is displayed, the data controller 14 causes the display unit 16 to display information as shown in FIG. 4. In the screen of FIG. 4, an image of the video processing apparatus (TV) is displayed at a center of the screen, and images of peripheral devices, such as an antenna, a digital versatile disc (DVD) recorder, a home theater, a digital camcorder, a karaoke microphone, a notebook computer, a game device, and a digital camera, are displayed around the image of the video processing apparatus. The user operates the user input unit 12 to select, on the screen of FIG. 4, a peripheral device which the user desires to connect to the video processing apparatus.

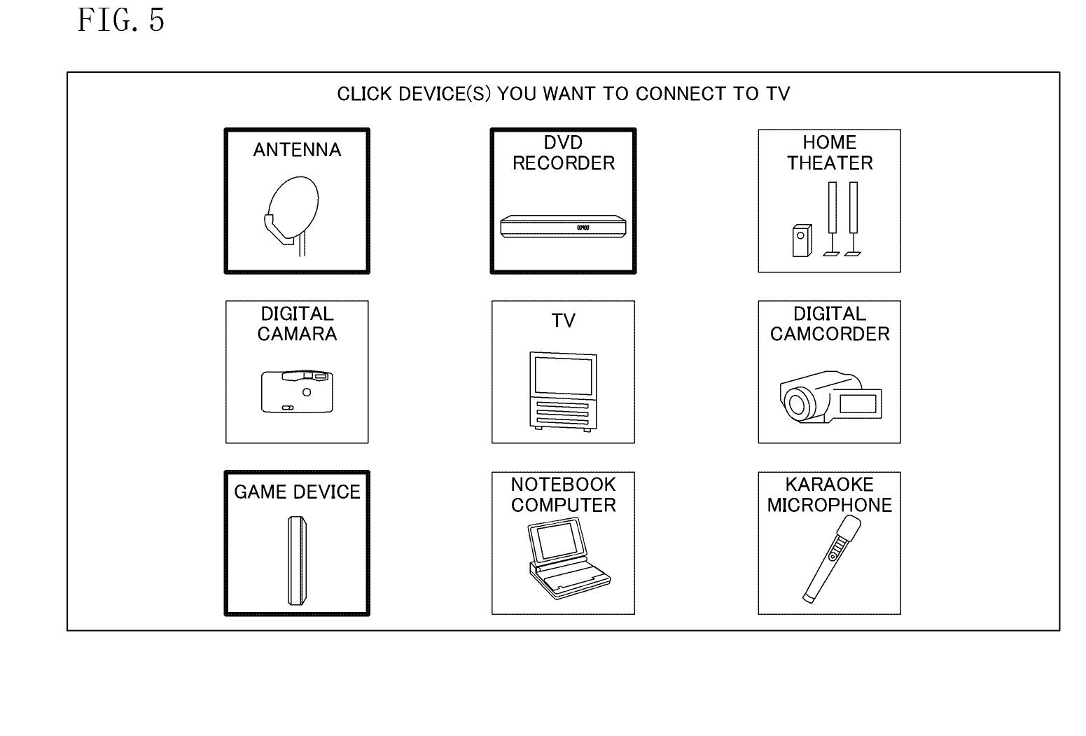

FIG. 5 is a diagram showing a state in which some of the peripheral devices have been selected on the screen of FIG. 4. Here, as an example, it is assumed that the user has selected the antenna, the DVD recorder, and the game device. The data controller 14 causes the storage unit 18 to store information indicative of the peripheral devices selected by the user.

Next, the data controller 14 reads out device data of the selected peripheral devices from the device data storage 32 based on the information input to the user input unit 12, and outputs the device data to the device connection determiner 52 of the connection analyzer 24. The device connection determiner 52 determines which connections between the video processing apparatus and the selected peripheral devices and between the selected peripheral devices should be provided, based on the received device data. In this case, the device connection determiner 52 uses the terminal information contained in the device data to determine whether or not the connections can be provided, which of the connections provide improved image quality, the number of cables required for connection, etc. The device connection determiner 52 outputs the result of the determination to the data controller 14 and the cable selector 54.

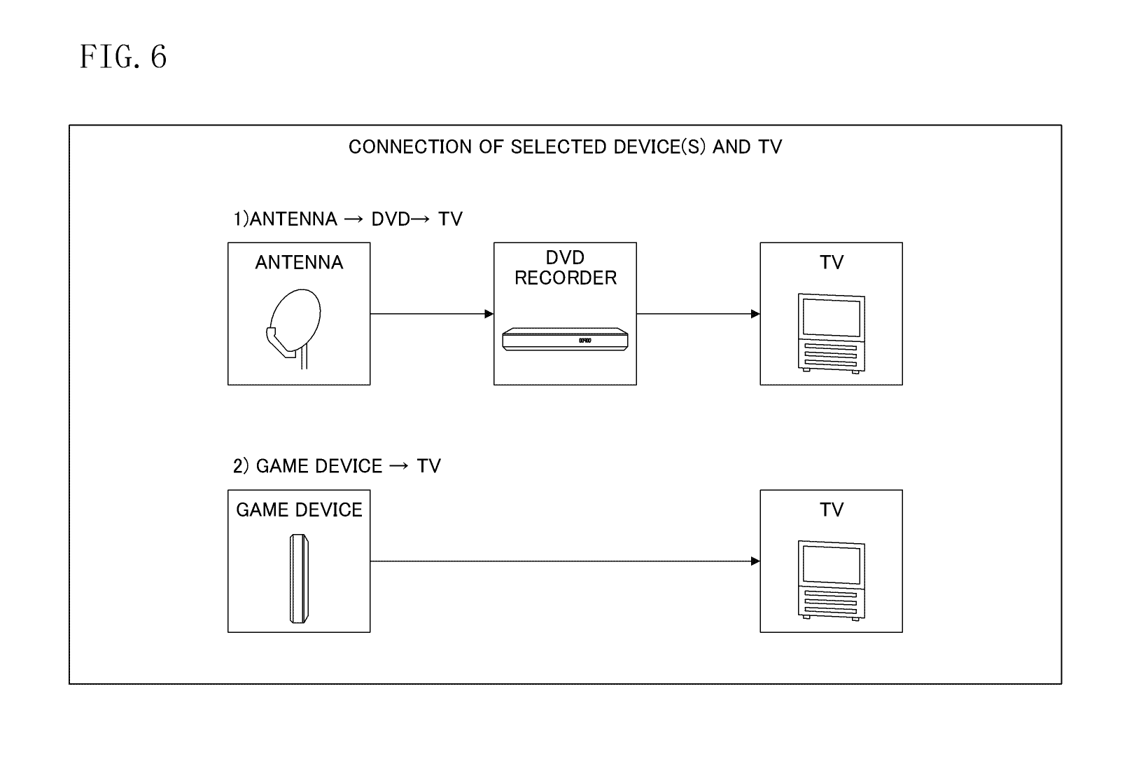

FIG. 6 is a diagram showing an example screen indicating connections between the video processing apparatus and peripheral devices and a connection between peripheral devices. After the screen of FIG. 5 is displayed, the data controller 14 causes the display unit 16 to display determined connections on the screen as shown in FIG. 6. The screen of

FIG. 6 shows the following connections using the images of the devices: 1) the antenna→the DVD recorder→the TV; and 2) the game device→the TV, where the arrows indicate the directions of signal flows.

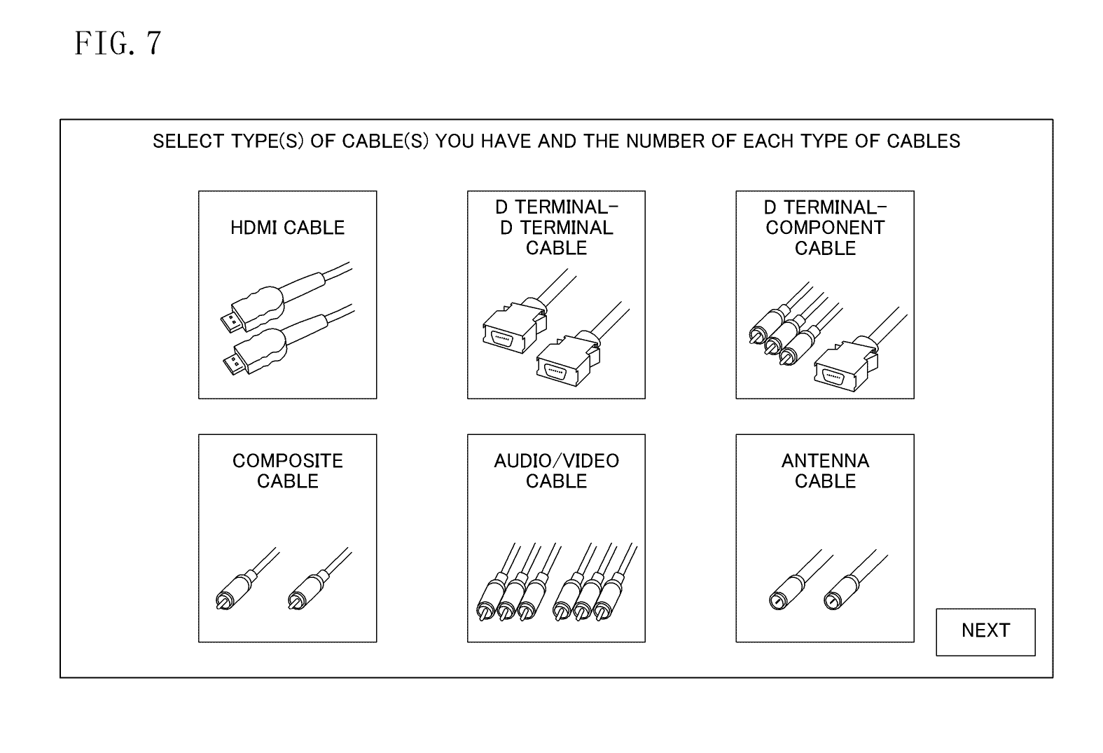

Next, a cable is selected. FIG. 7 is a diagram showing an example screen displaying a list of cables. After the screen of FIG. 6 is displayed, the data controller 14 causes the display unit 16 to display images (e.g., FIG. 7) of cables which can be connected to the video processing apparatus of FIG. 1. As shown in the screen of FIG. 7, the data controller 14 causes the display unit 16 to display, for example, six types of cables along with the names thereof. The screen of FIG. 7 shows, for example, an HDMI cable, a D terminal-D terminal cable, a D terminal-component cable, a composite cable, an audio/video cable, and an antenna cable. The images of the cables include images of terminals thereof which allow the user to recognize the types of the terminals.

The user operates the user input unit 12 to select an available cable or cables on the screen of FIG. 7. When two or more cables of the same type are available, the user inputs the number of the cables. When the user operates the user input unit 12 to select a “NEXT” button, the data controller 14 causes the display unit 16 to display images of other types of cables along with the names thereof.

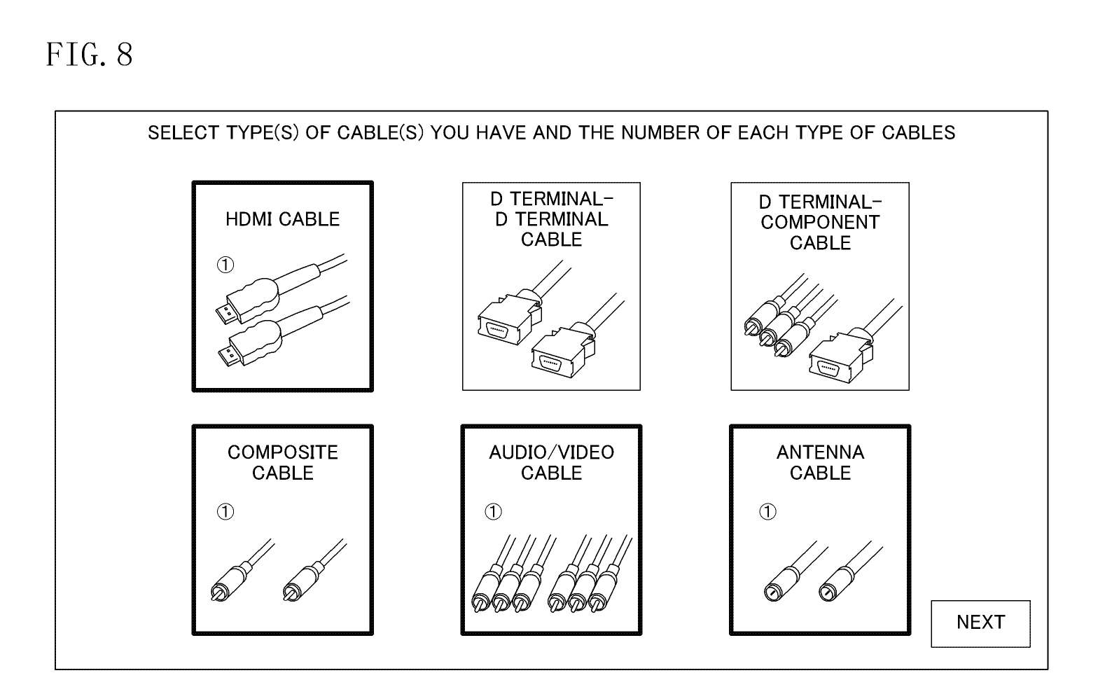

FIG. 8 is a diagram for describing a state in which some cables have been selected on the screen of FIG. 7. Here, as an example, it is assumed that the user has selected an HDMI cable, a composite cable, an audio/video cable, and an antenna cable, and the number of cables is one for each of the selected cable types. The data controller 14 causes the storage unit 18 to store the cable types and the numbers of cables selected by the user.

Next, the data controller 14 reads out cable data of the selected cables from the cable data storage 34 based on the information input to the user input unit 12, and outputs the cable data to the cable selector 54 of the connection analyzer 24. The cable selector 54 determines which of the selected cables should be used to provide connections which have been determined to be provided between the video processing apparatus and the peripheral devices and between the peripheral devices, based on the received device data and cable data. In this case, the cable selector 54 uses terminal information contained in the device data and the cable data to select cables in order that highest image quality can be provided (i.e., higher priority is given to image quality), taking into consideration which cable is available, which cable provides higher image quality, etc.

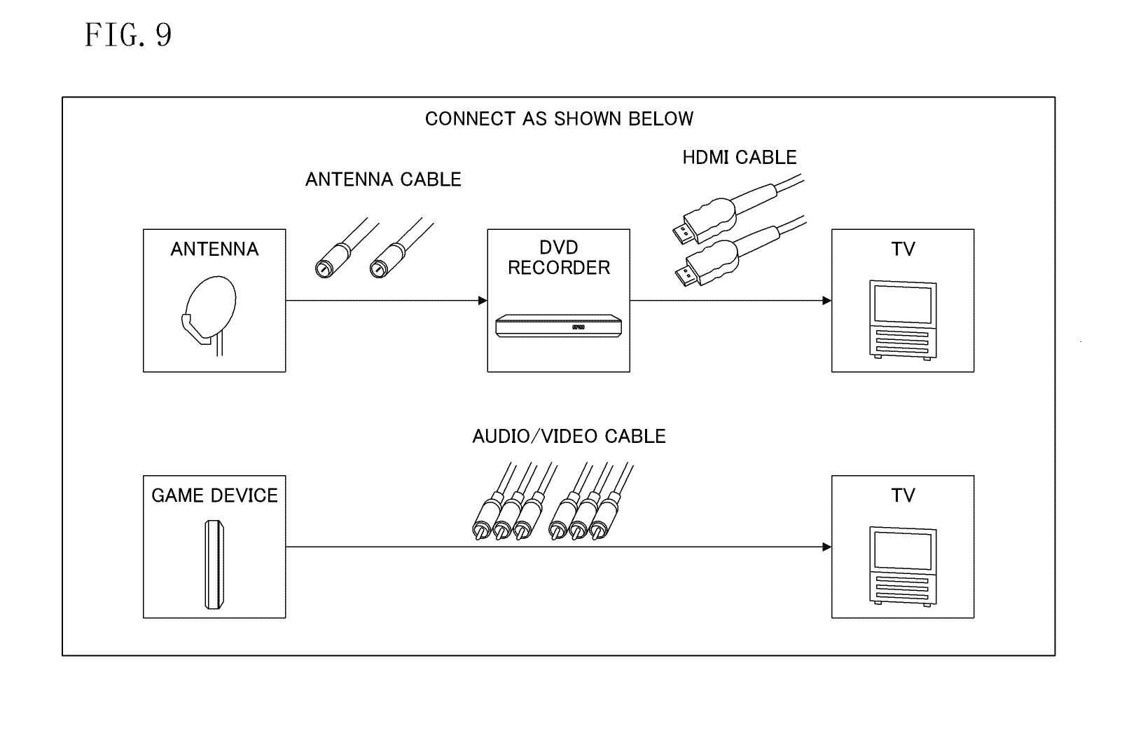

FIG. 9 is a diagram showing an example screen displaying the video processing apparatus, the peripheral devices, and the cables used for connection. After the screen of FIG. 8 is displayed, the data controller 14 causes the display unit 16 to display images (e.g., FIG. 9) of the cables selected by the cable selector 54 along with images of the video processing apparatus (TV) and the peripheral devices selected by the user.

In FIG. 9, as an example, it is shown that an HDMI cable should be used to connect the DVD recorder and the video processing apparatus together. Because an image having higher image quality can be displayed when an “HDMI cable” is used than when a “composite cable” is used, the cable selector 54 selects an HDMI cable, where higher priority is given to image quality. Also, it is shown that an antenna cable should be used to connect the antenna and the DVD recorder together, and an audio/video cable should be used to connect the game device and the video processing apparatus together.

The menu data storage 22 stores display data for indicating that there is a lack of cables. When a cable or cables for connection are determined, then if the selected cable or cables are not enough to provide required connections, i.e., there is a lack of cables, the cable selector 54 notifies the data controller 14 of a lacking cable or cables. The data controller 14, when receiving the notification of the lack of cables, reads out images of the lacking cables from the cable data storage 34, and display data indicating that there is a lack of cables from the menu data storage 22, and causes the display unit 16 to display the read images and display data. In this case, the data controller 14 may read out, from the menu data storage 22, display data indicating a recommendation that the user should purchase the lacking cables, and cause the display unit 16 to display the display data.

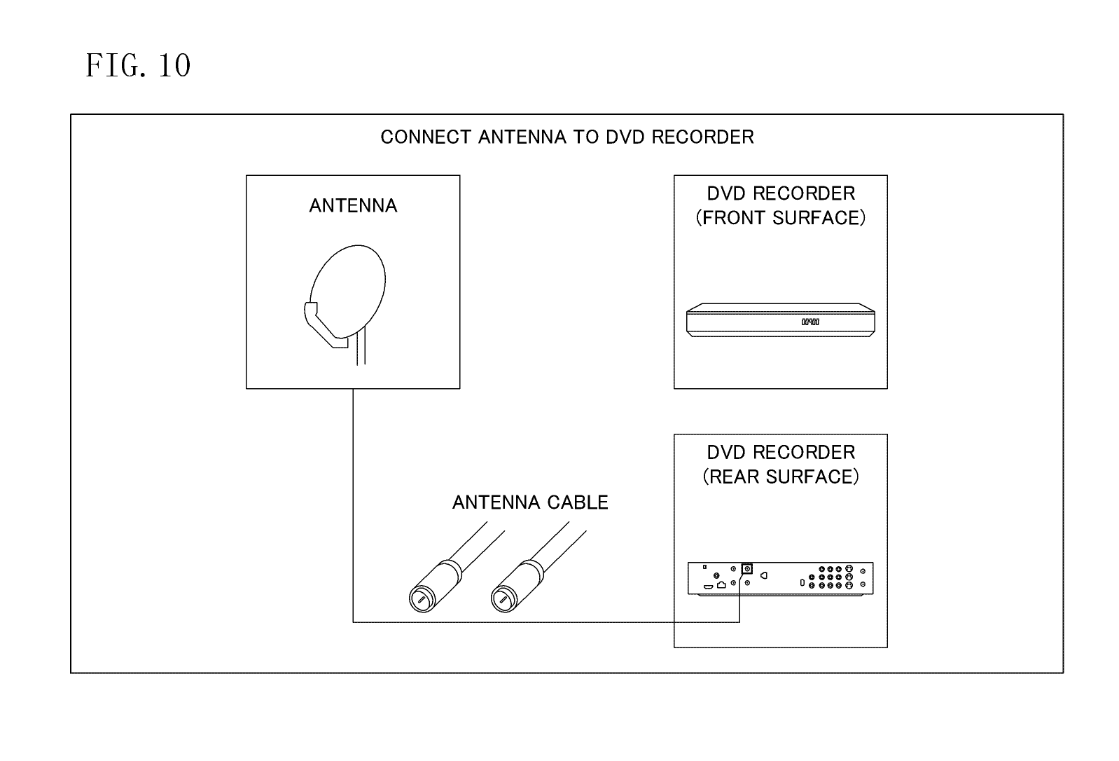

Thereafter, a guidance screen for connection using a cable or cables is displayed, and the user performs a task of connection based on the guidance screen. Initially, the antenna and the DVD recorder are connected together. FIG. 10 is a diagram showing a guidance screen for connecting the antenna and the DVD recorder together.

The data controller 14 reads out an antenna image, a DVD recorder image (front surface), and a DVD recorder image (rear surface) from the device data storage 32, and an antenna cable image from the cable data storage 34, and causes the display unit 16 to display the read images as shown in FIG. 10. As the DVD recorder image (rear surface), an image which allows the user to recognize each terminal is displayed.

The menu data storage 22 stores display data (on-screen display (OSD) data) for indicating a terminal to which a cable should be connected. The data controller 14 reads out such OSD data from the menu data storage 22, and causes the display unit 16 to display an image indicating a terminal to which the selected antenna cable should be connected so that the image is superimposed on the DVD recorder image (rear surface). The OSD data refers to data representing a pictorial figure, such as a red circle etc., which surrounds a terminal to which a cable should be connected. Therefore, the user can understand at a glance to which of terminals a cable should be connected. The user connects the antenna cable to the terminal indicated by the OSD data on the rear surface of the DVD recorder based on the display of FIG. 10.

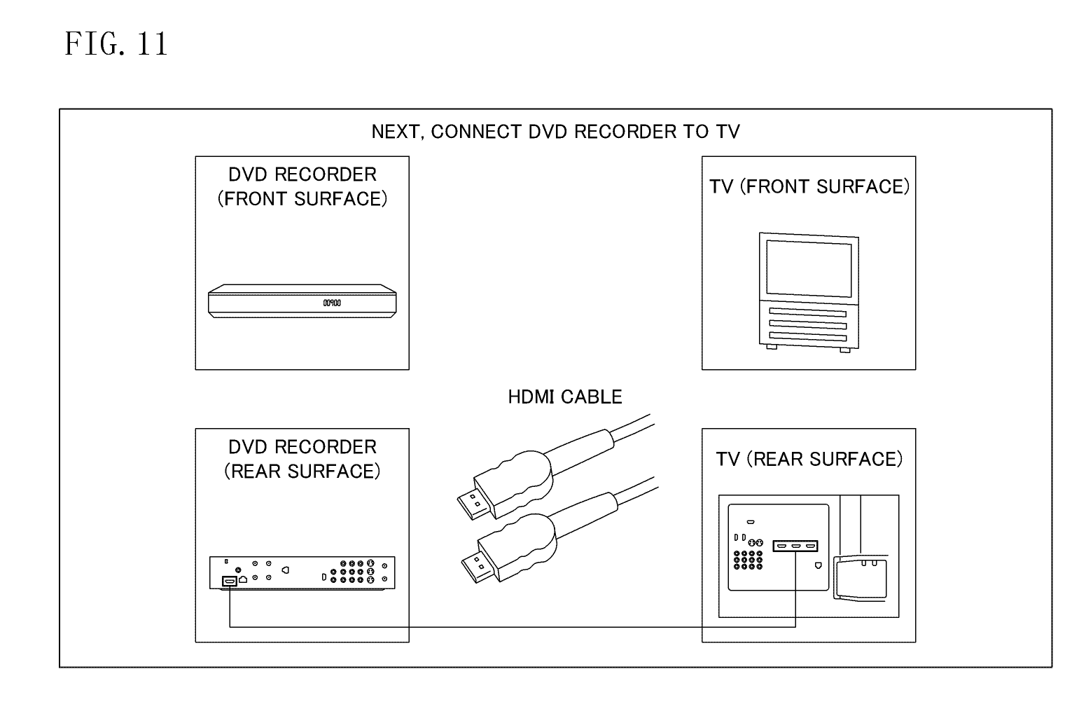

Next, the DVD recorder and the video processing apparatus are connected together. FIG. 11 is a diagram showing a guidance screen for connecting the DVD recorder and the video processing apparatus together.

The data controller 14 reads out a DVD recorder image (front surface), a DVD recorder image (rear surface), a TV image (front surface), and a TV image (rear surface) from the device data storage 32, and an HDMI cable image from the cable data storage 34, and causes the display unit 16 to display the read images as shown in FIG. 11. As the DVD recorder image (rear surface) and the TV image (rear surface), an image which allows the user to recognize each terminal is displayed.

In the case of FIG. 11, as in FIG. 10, the data controller 14 reads out, from the menu data storage 22, OSD data for indicating a terminal to which a cable should be connected, and causes the display unit 16 to display images indicating terminals to which the selected HDMI cable should be connected so that the images are superimposed on the DVD recorder image (rear surface) and the TV image (rear surface). The user connects the HDMI cable to the terminal on the rear surface of the DVD recorder indicated by the OSD data and the terminal on the rear surface of the TV indicated by the OSD data based on the display of FIG. 11.

Next, it is confirmed whether or not the antenna, the DVD recorder, and the video processing apparatus are correctly connected together. The data controller 14 reads out, from the menu data storage 22, OSD data for displaying instructions to turn on the DVD recorder (e.g., a message “TURN ON DVD RECORDER” is displayed), and causes the display unit 16 to display the OSD data. The user turns on the DVD recorder based on the display of the screen. A signal output from the DVD recorder is input via the signal input unit 26 to the synchronization signal detector 28 as shown in FIG. 1. The synchronization signal detector 28 detects a synchronization signal contained in the input video signal, and notifies the data controller 14 of that detection.

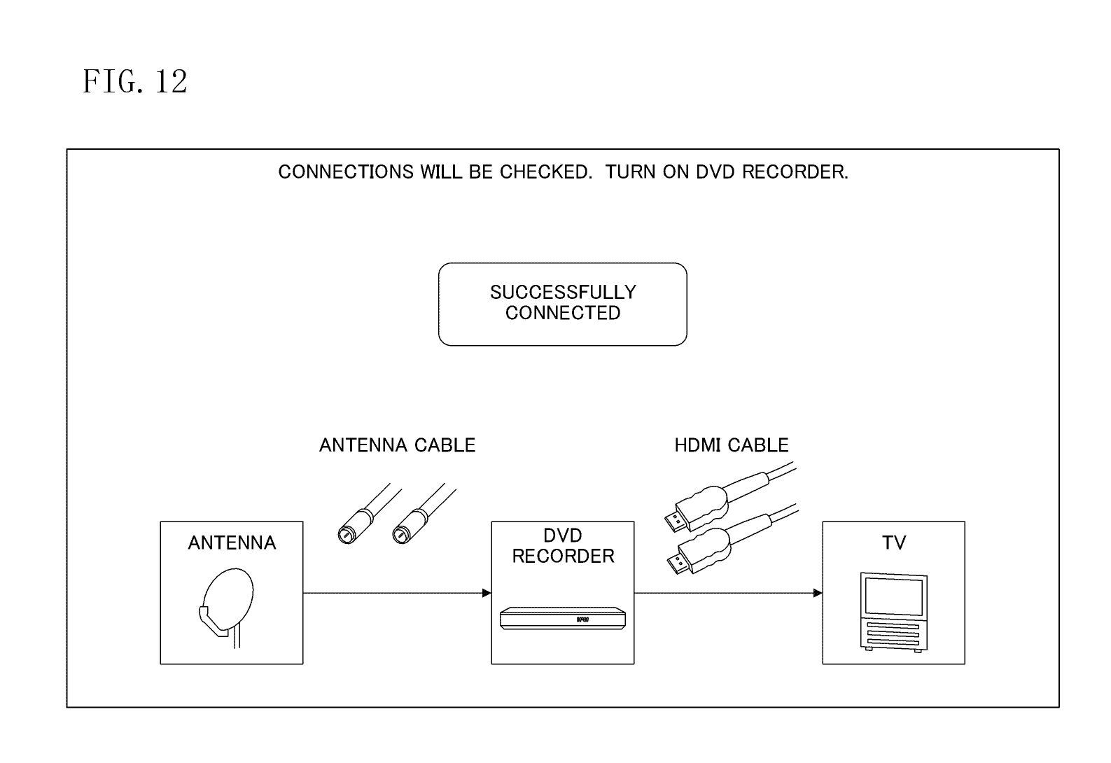

FIG. 12 is a diagram showing a screen displayed when the antenna, the DVD recorder, and the video processing apparatus are correctly connected together. When notified of the detection of the synchronization signal from the synchronization signal detector 28, the data controller 14 reads out, from the menu data storage 22, OSD data for displaying a message that correct connections are provided (e.g., a message “SUCCESSFULLY CONNECTED” is displayed), and causes the display unit 16 to display the OSD data as shown in FIG. 12.

Note that when there are instructions for a cable selected by the user as in the case of an HDMI cable, the data controller 14 may cause the display unit 16 to display the instructions.

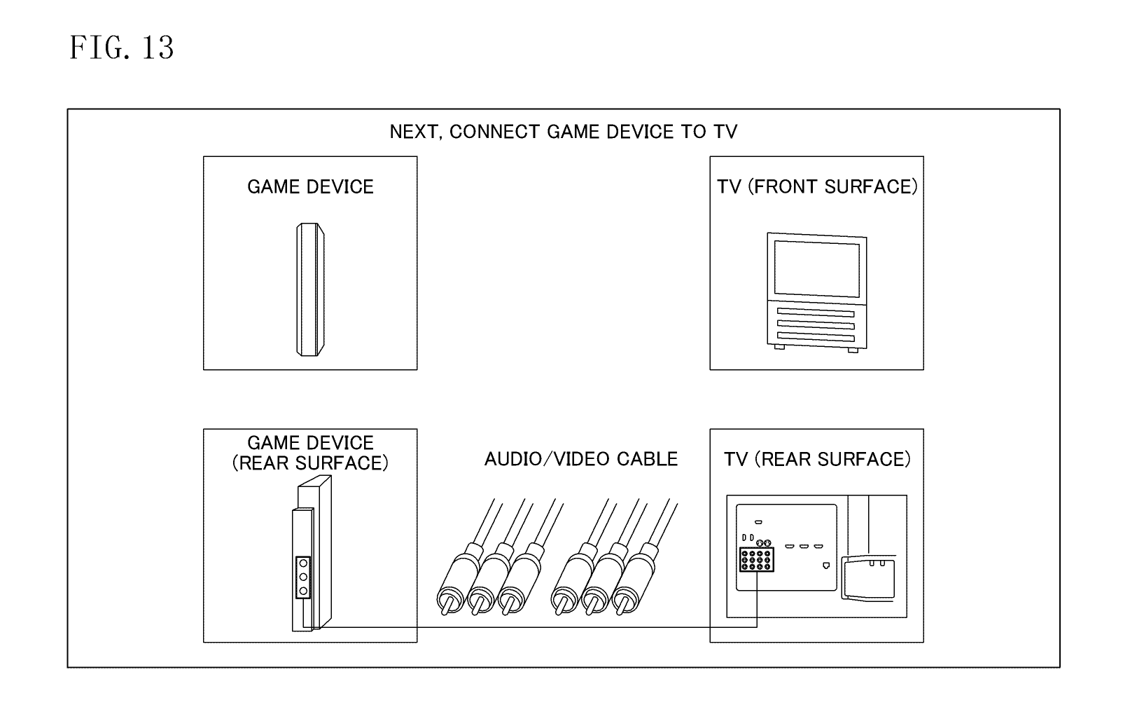

Next, the game device and the video processing apparatus are connected together. FIG. 13 is a diagram showing a guidance screen for connecting the game device and the video processing apparatus together.

The data controller 14 reads out a game device image (front surface), a game device image (rear surface), a TV image (front surface), and a TV image (rear surface) from the device data storage 32, and an audio/video cable image from the cable data storage 34, and causes the display unit 16 to display the read images as shown in FIG. 13. As the game device image (rear surface) and the TV image (rear surface), an image which allows the user to recognize each terminal is displayed.

In the case of FIG. 13, as in FIG. 10, the data controller 14 reads out, from the menu data storage 22, OSD data for indicating terminals to which a cable is connected, and causes the display unit 16 to display the OSD data. The user connects an audio/video cable to the terminals on the rear surface of the game device indicated by the OSD data and the terminals on the rear surface of the TV indicated by the OSD data based on the displayed information of FIG. 13.

Next, it is confirmed whether or not the game device and the video processing apparatus are correctly connected together. The data controller 14 reads out, from the menu data storage 22, OSD data for displaying instructions to turn on the game device (e.g., a message “TURN ON GAME DEVICE” is displayed), and causes the display unit 16 to display the OSD data. The user turns on the game device based on the displayed information on the screen. A signal output from the game device is input via the signal input unit 26 to the synchronization signal detector 28 as shown in FIG. 1. The synchronization signal detector 28 detects a synchronization signal contained in the input video signal, and notifies the data controller 14 of that detection.

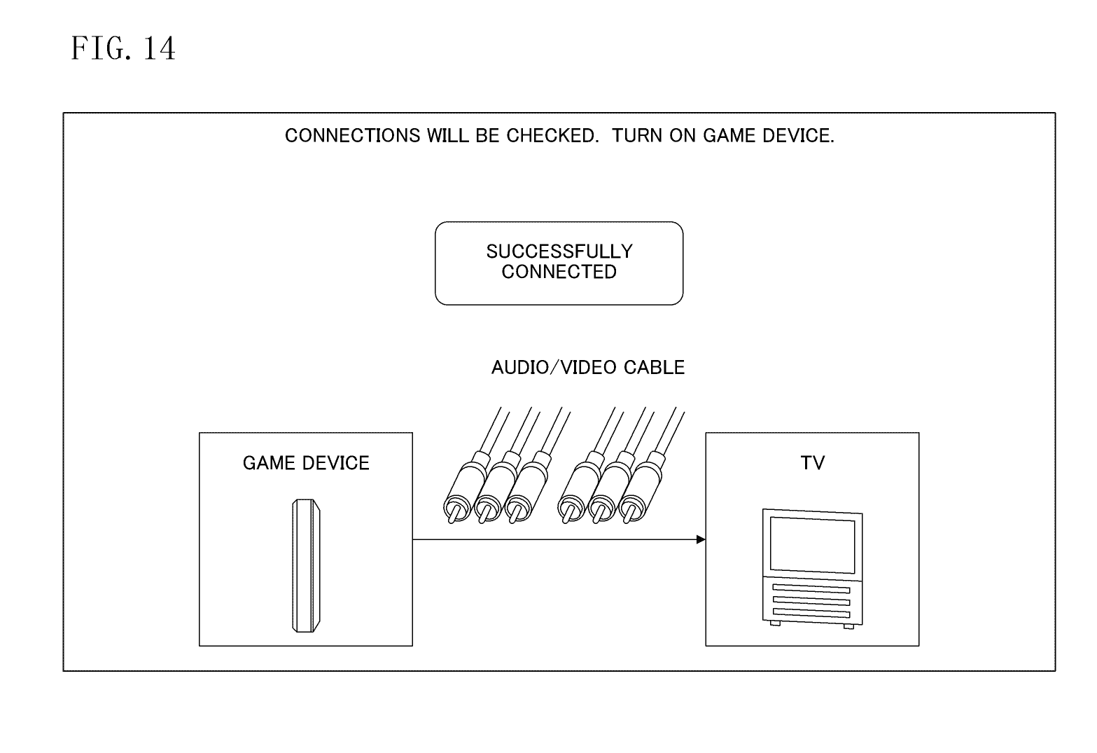

FIG. 14 is a diagram showing a screen displayed when the game device and the video processing apparatus are correctly connected together. When notified of the detection of the synchronization signal from the synchronization signal detector 28, the data controller 14 reads out, from the menu data storage 22, OSD data for displaying a message that correct connections are provided (e.g., a message “SUCCESSFULLY CONNECTED” is displayed), and causes the display unit 16 to display the OSD data as shown in FIG. 14.

Thus, the connection procedure is completed. Thereafter, if a cable is disconnected, similar images are displayed, and the user needs to perform a task of connection based on the displayed images. In this case, the data controller 14 determines which peripheral devices and cables have been selected by the user, based on the data stored in the storage unit 18 which indicates the selected peripheral device or devices, cable or cables, and the number of cables. As a result, the user can perform a task of connection without inputting a peripheral device or devices, a cable or cables, and the number of cables again.

Although the video processing apparatus of FIG. 1 includes the LAN interface 42, the memory card reader 44, and the HDD 46 in this embodiment, the video processing apparatus may include at least one of the LAN interface 42, the memory card reader 44, and the HDD 46.

The many features and advantages of the present disclosure are apparent from the written description, and thus, it is intended by the appended claims to cover all such features and advantages of the present disclosure. Further, since numerous modifications and changes will readily occur to those skilled in the art, it is not desired to limit the present disclosure to the exact configurations and operations as illustrated and described. Hence, all suitable modifications and equivalents may be resorted to as falling within the scope of the present disclosure.

As described above, according to the embodiments of the present disclosure, a video processing apparatus and a peripheral device can be more easily connected together, and therefore, the present disclosure is useful for video processing apparatuses etc.

What is claimed is:

1. A video processing apparatus comprising:
a device data storage configured to store device data which is information about connection of peripheral device devices;
a cable data storage configured to store cable data which is information about cables;
a data controller configured to read out the device data of a selected one of the peripheral devices from the device data storage, and the cable data of a selected one of the cables from the cable data storage;
a connection analyzer configured to determine one of the cables which is used to connect the video processing apparatus and the selected peripheral device together, based on the device data read out from the device data storage and the cable data read out from the cable data storage; and
a display unit configured to display an image of the cable determined by the connection analyzer along with an image of the selected peripheral device.

2. The video processing apparatus of claim 1, wherein the data controller causes the display unit to display images of ones of the cables which can be connected to the video processing apparatus, and the selected cable is the cable selected from the cables whose images are displayed on the display unit.

3. The video processing apparatus of claim 1, wherein the connection analyzer determines the one of the cables used for the connection, based on the read cable data, where higher priority is given to image quality.

4. The video processing apparatus of claim 1, further comprising:
a menu data storage configured to store display data indicating that there is a lack of cables,
wherein
the connection analyzer, when determining the one of the cables used for the connection, then if there is a lack of cables, notifies the data controller of the lack of cables, and
the data controller, when notified of the lack of cables, reads out the display data from the menu data storage and causes the display unit to display the display data.

5. The video processing apparatus of claim 1, further comprising:
a menu data storage configured to store display data for showing a terminal to which a cable should be connected,
wherein
the data controller reads out the display data from the menu data storage, and causes the display unit to display an image indicating a terminal to which the selected cable should be connected so that the image is superimposed on an image of the video processing apparatus or the selected peripheral device.

6. The video processing apparatus of claim 1, wherein
the data controller causes the display unit to display instructions for the selected cable.

7. The video processing apparatus of claim 1, further comprising:
a synchronization signal detector configured to detect a synchronization signal contained in an input signal,
wherein
the data controller, when the synchronization signal detector detects the synchronization signal, causes the display unit to display a message that a connection is provided.

8. The video processing apparatus of claim 1, further comprising:
a storage unit configured to store data indicating the selected peripheral device and the selected cable,
wherein
the data controller determines the selected peripheral device and the selected cable, using data stored in the storage unit.
